(19) United States
(12) Patent Application Publication
(10) Pub. No.: US 2017/0303144 A1
(43) Pub. Date: Oct. 19, 2017

(54) METHOD AND APPARATUS FOR DYNAMIC TDD

(71) Applicant: Samsung Electronics Co., Ltd, Suwon-si (KR)

(72) Inventors: Li Guo, Allen, TX (US); Boon Loong Ng, Plano, TX (US)

(21) Appl. No.: 15/385,513

(22) Filed: Dec. 20, 2016

Related U.S. Application Data
(60) Provisional application No. 62/324,075, filed on Apr. 18, 2016.
(60) Provisional application No. 62/373,633, filed on Aug. 11, 2016.
(60) Provisional application No. 62/384,893, filed on Sep. 8, 2016.

(51) Int. Cl. H04W 24/02; H04L 5/14; H04B 17/318; H04L 5/00; H04W 74/08; H04W 72/12

(52) U.S. Cl. CPC H04W 24/02; H04W 74/0808; H04W 72/121; H04B 17/318; H04L 5/0048; H04L 5/14

(57) ABSTRACT

A method of user equipment (UE) in a wireless communication system. The method comprises receiving, from a base station (BS) over a first downlink channel, a neighbor cell list comprising at least one neighbor cell, measuring a reference signal received power (RSRP) of a reference signal (RS) received from the at least one neighbor cell included in the neighbor cell list, generating an indication based on the measured RSRP of the RS that is compared with a first threshold configured by the BS, and transmitting the indication to the BS over an uplink channel. Additionally, the method may include receiving information for a clear channel assessment (CCA) operation from the BS for an uplink transmission, measuring signal energy of a channel for the uplink transmission, and determining whether to adjust a length of the uplink transmission based on a result of the measurement.

The present application claims priority to U.S. Provisional Patent Application Ser. No. 62/324,075, filed on Apr. 18, 2016, entitled “Method and Apparatus for Dynamic TDD;” U.S. Provisional Patent Application Ser. No. 62/373,633, filed on Aug. 11, 2016, entitled “Method and Apparatus for Dynamic TDD;” and U.S. Provisional Patent Application Ser. No. 62/384,893, filed on Sep. 8, 2016, entitled “Method and Apparatus for dynamic TDD.” The content of the above-identified patent documents are incorporated herein by reference.

### TECHNICAL FIELD

The present application relates generally to advanced communication systems. More specifically, this disclosure relates to dynamic time-division duplexing techniques in advanced communication systems.

### BACKGROUND

5^{th} generation (5G) mobile communications, initial commercialization of which is expected around 2020, is recently gathering increased momentum with all the worldwide technical activities on the various candidate technologies from industry and academia. The candidate enablers for the 5G mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on. The International Telecommunication Union (ITU) has categorized the usage scenarios for international mobile telecommunications (IMT) for 2020 and beyond into 3 main groups such as enhanced mobile broadband, massive machine type communications (MTC), and ultra-reliable and low latency communications. In addition, the ITC has specified target requirements such as peak data rates of 20 gigabit per second (Gb/s), user experienced data rates of 100 megabit per second (Mb/s), a spectrum efficiency improvement of 3×, support for up to 500 kilometer per hour (km/h) mobility, 1 millisecond (ms) latency, a connection density of 10⁶ devices/km², a network energy efficiency improvement of 100× and an area traffic capacity of 10 Mb/s/m². While all the requirements need not be met simultaneously, the design of 5G networks should provide flexibility to support various applications meeting part of the above requirements on a use case basis.

### SUMMARY

The present disclosure relates to a pre-5^{th}-Generation (5G) or 5G communication system to be provided for supporting higher data rates beyond 4^{th}-Generation (4G) communication system such as long term evolution (LTE). Embodiments of the present disclosure provide multiple services in advanced communication systems.

In one embodiment, a user equipment (UE) in a wireless communication system is provided. The UE includes a transceiver configured to receive, from a base station (BS) over a first downlink channel, a neighbor cell list comprising at least one neighbor cell. The UE further includes at least one processor configured to measure a reference signal received power (RSRP) of a reference signal (RS) received from the at least one neighbor cell included in the neighbor cell list and generate an indication based on the measured RSRP of the RS that is compared with a first threshold configured by the BS. The transceiver is further configured to transmit the indication to the BS over an uplink channel.

In another embodiment, a base station (BS) in a wireless communication system is provided. The BS includes at least one processor configured to determine a user equipment (UE) to measure a reference signal (RS) of at least one neighbor cell. The BS further includes a transceiver configured to transmit, to the UE over a first downlink channel, a neighbor cell list comprising the at least one neighbor cell and receive, from the UE, an indication including a measured reference signal received power (RSRP) of a reference signal (RS) received from the at least one neighbor cell included in the neighbor cell list based on a first threshold information configured by the BS.

In yet another embodiment, a method of user equipment (UE) in a wireless communication system is provided. The method comprises receiving, from a base station (BS) over a first downlink channel, a neighbor cell list comprising at least one neighbor cell, measuring a reference signal received power (RSRP) of a reference signal (RS) received from the at least one neighbor cell included in the neighbor cell list, generating an indication based on the measured RSRP of the RS that is compared with a first threshold configured by the BS, and transmitting the indication to the BS over an uplink channel.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example eNB according to embodiments of the present disclosure;

FIG. 3 illustrates an example UE according to embodiments of the present disclosure;

FIG. 4A illustrates a high-level diagram of an orthogonal frequency division multiple access transmit path according to embodiments of the present disclosure;

FIG. 4B illustrates a high-level diagram of an orthogonal frequency division multiple access receive path according to embodiments of the present disclosure;

FIG. 5 illustrates a time-division duplexing (TDD) scheme according to embodiments of the present disclosure;

FIG. 6 illustrates a TDD frame structure according to embodiments of the present disclosure;

FIG. 7 illustrates a TDD configuration according to embodiments of the present disclosure;

FIG. 8 illustrates a dynamic TDD wireless system according to embodiments of the present disclosure;

FIG. 9 illustrates a frame structure of a dynamic TDD wireless system according to embodiments of the present disclosure;

FIG. 10 illustrates another frame structure of a dynamic TDD wireless system according to embodiments of the present disclosure;

FIG. 11 illustrates yet another frame structure of dynamic TDD wireless system according to embodiments of the present disclosure;

FIG. 12 illustrates yet another frame structure of dynamic TDD wireless system according to embodiments of the present disclosure;

FIG. 13 illustrates a transmission scheme on listen-before-talk (LBT) mechanism according to embodiments of the present disclosure;

FIG. 14 illustrates a process for a clear channel assessment procedure according to embodiments of the present disclosure;

FIG. 15 illustrates a configuration of multiple LBT locations according to embodiments of the present disclosure;

FIG. 16 illustrates another process for a clear channel assessment procedure according to embodiments of the present disclosure;

FIG. 17 illustrates a process for a victim user equipment (UE) discovery-reference signal (VUD-RS) transmission according to embodiments of the present disclosure;

FIG. 18 illustrates a measurement method for VUD-RS transmission according to embodiments of the present disclosure;

FIG. 19A illustrates an uplink demodulation-reference signal resource element (UL DM-RS RE) mapping according to embodiments of the present disclosure;

FIG. 19B illustrates a downlink demodulation-reference signal resource element (DL DM-RS RE) mapping according to embodiments of the present disclosure;

FIG. 20 illustrates a downlink transmission method according to embodiments of the present disclosure;

FIG. 21 illustrates a process for a multi-shot channel state information-reference signal (CSI-RS) transmission according to embodiments of the present disclosure;

FIG. 22 illustrates a special downlink transmission for UL-to-DL measurement according to embodiments of the present disclosure; and

FIG. 23 illustrates a transmit time interval (TTI) transmission according to embodiments of the present disclosure.

### DETAILED DESCRIPTION

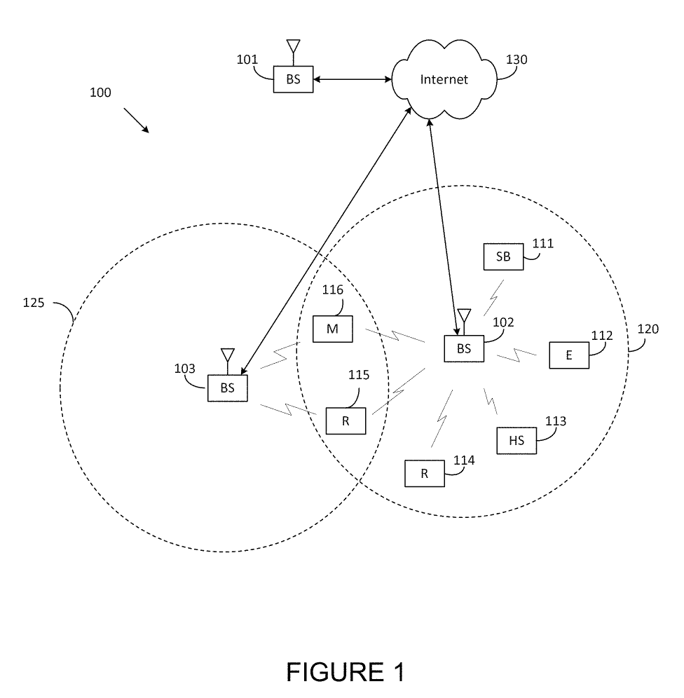

FIG. 1 through FIG. 23, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: 3GPP TS 36.211 v12.3.0, “E-UTRA, Physical channels and modulation” (REF 1); 3GPP TS 36.212 v12.2.0, “E-UTRA, Multiplexing and Channel coding” (REF 2); 3GPP TS 36.213 v12.3.0, “E-UTRA, Physical Layer Procedures” (REF 3); 3GPP TS 36.216 v12.0.0, “E-UTRA Physical Layer for Relaying Operation” (REF 4); 3GPP TS 36.300 v13.0.0, “E-UTRA and E-UTRAN, Overall Description, Stage 2” (REF 5); and 3GPP TS36.331 v12.3.0, “E-UTRA, Radio Resource Control (RRC) protocol specification” (REF 6).

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission coverage, the beamforming, massive multiple-input multiple-output (MIMO), full dimensional MIMO (FD-MIMO), array antenna, an analog beam forming, large scale antenna techniques and the like are discussed in 5G communication systems.

In addition, in 5G communication systems, development for system network improvement is under way based on advanced small cells, cloud radio access networks (RANs), ultra-dense networks, device-to-device (D2D) communication, wireless backhaul communication, moving network, cooperative communication, coordinated multi-points (CoMP) transmission and reception, interference mitigation and cancellation and the like.

In the 5G system, hybrid frequency shift keying and quadrature amplitude modulation (FQAM) and sliding window superposition coding (SWSC) as an adaptive modulation and coding (AMC) technique, and filter bank multi carrier (FBMC), non-orthogonal multiple access (NOMA), and sparse code multiple access (SCMA) as an advanced access technology have been developed.

FIGS. 1-4B below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network 100 according to embodiments of the present disclosure. The embodiment of the wireless network shown in FIG. 1 100 is for illustration only. Other embodiments of the wireless network 100 could be used without departing from the scope of this disclosure.

As shown in FIG. 1, the wireless network includes an eNB 101, an eNB 102, and an eNB 103. The eNB 101 communicates with the eNB 102 and the eNB 103. The eNB 101 also communicates with at least one network 130, such as the Internet, a proprietary Internet Protocol (IP) network, or other data network.

The eNB 102 provides wireless broadband access to the network 130 for a first plurality of user equipments (UEs) within a coverage area 120 of the eNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The eNB 103 provides wireless broadband access to the network 130 for a second plurality of UEs within a coverage area 125 of the eNB 103. The second plurality of UEs includes the UE 115 and the UE 116. In some embodiments, one or more of the eNBs 101-103 may communicate with each other and with the UEs 111-116 using 5G, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio interface/access (NR), long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with eNBs, such as the coverage areas 120 and 125, may have other shapes, including irregular shapes, depending upon the configuration of the eNBs and variations in the radio environment associated with natural and man-made obstructions.

As described in more detail below, one or more of the UEs 111-116 include circuitry, programing, or a combination thereof, for dynamic TDD in an advanced wireless communication system. In certain embodiments, and one or more of the eNBs 101-103 includes circuitry, programing, or a combination thereof, for dynamic TDD in an advanced wireless communication system.

Although FIG. 1 illustrates one example of a wireless network 100, various changes may be made to FIG. 1. For example, the wireless network could include any number of eNBs and any number of UEs in any suitable arrangement. Also, the eNB 101 could communicate directly with any number of UEs and provide those UEs with wireless broadband access to the network 130. Similarly, each eNB 102-103 could communicate directly with the network 130 and provide UEs with direct wireless broadband access to the network 130. Further, the eNBs 101, 102, and/or 103 could provide access to other or additional external networks, such as external telephone networks or other types of data networks.

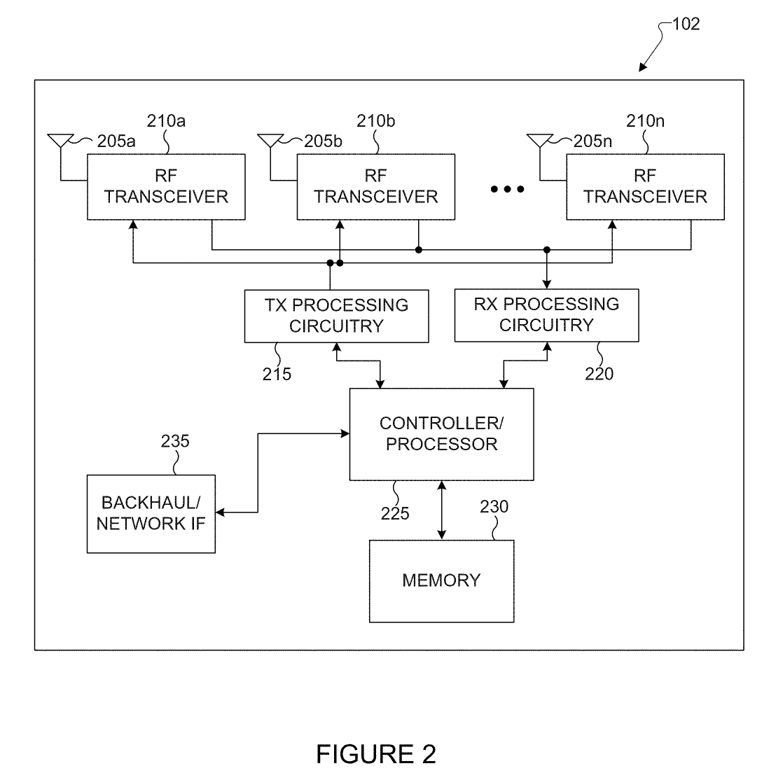

FIG. 2 illustrates an example eNB 102 200 according to embodiments of the present disclosure. The embodiment of the eNB 102 illustrated in FIG. 2 is for illustration only, and the eNBs 101 and 103 of FIG. 1 could have the same or similar configuration. However, eNBs come in a wide variety of configurations, and FIG. 2 does not limit the scope of this disclosure to any particular implementation of an eNB.

As shown in FIG. 2, the eNB 102 includes multiple antennas 205a-205n, multiple RF transceivers 210a-210n, transmit (TX) processing circuitry 215, and receive (RX) processing circuitry 220. The eNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

In some embodiments, the RF transceiver 210a-201n is also capable of transmitting, to the UE over a first downlink channel, a neighbor cell list comprising the at least one neighbor cell and receiving, from the UE, an indication including a measured reference signal received power (RSRP) of a reference signal (RS) received from the at least one neighbor cell included in the neighbor cell list based on a first threshold information configured by the BS.

In some embodiments, the RF transceiver 210a-201n is also capable of receiving uplink-to-downlink interference based on the measured RSRP of the RS received from the at least one neighbor cell included in the neighbor cell list.

In some embodiments, the RF transceiver 210a-201n is also capable of transmitting configuration information including first discovery RS information over the first downlink channel.

In some embodiments, the RF transceiver 210a-201n is also capable of transmitting information for a clear channel assessment (CCA) operation to the UE for an uplink transmission by the UE and receiving the uplink transmission using a first uplink transmission when the CCA operation is available.

In some embodiments, the RF transceiver 210a-201n is also capable of receiving the uplink transmission based on an adjusted transport block (TB) size using a second uplink transmission that is located at an end of a transmit time interval (TTI), and wherein a portion of the second uplink transmission located in the TTI is equal to or smaller than the first uplink transmission, located in the TTI, by at least one neighbor UE.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the eNB 102. For example, the controller/processor 225 could control the reception of forward channel signals and the transmission of reverse channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. Any of a wide variety of other functions could be supported in the eNB 102 by the controller/processor 225.

In some embodiments, the controller/processor 225 includes at least one microprocessor or microcontroller. For example, controller/processor 225 can be configured to execute one or more instructions, stored in memory 230, that are configured to cause the controller/processor to process vector quantized feedback components such as channel coefficients.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the eNB 102 to communicate with other devices or systems over a backhaul connection or over a network. The interface 235 could support communications over any suitable wired or wireless connection(s). For example, when the eNB 102 is implemented as part of a cellular communication system (such as one supporting 5G, LTE, or LTE-A), the interface 235 could allow the eNB 102 to communicate with other eNBs over a wired or wireless backhaul connection. When the eNB 102 is implemented as an access point, the interface 235 could allow the eNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

In at least some embodiments, the controller/processor 225 is also capable of measuring a reference signal (RS) of at least one neighbor cell. In at least some embodiments, the controller/processor 225 is also capable of scheduling the UE in at least one of a synchronized transmit time interval (TTI) or an asynchronized TTI. In at least some embodiments, the controller/processor 225 is also capable of performing a blind data decoding for the received uplink transmission.

The memory 230 is coupled to the controller/processor 225. Part of the memory 230 could include a RAM, and another part of the memory 230 could include a Flash memory or other ROM.

Although FIG. 2 illustrates one example of eNB 102, various changes may be made to FIG. 2. For example, the eNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the eNB 102 could include multiple instances of each (such as one per RF transceiver). Also, various components in FIG. 2 could be combined, further subdivided, or omitted and additional components could be added according to particular needs.

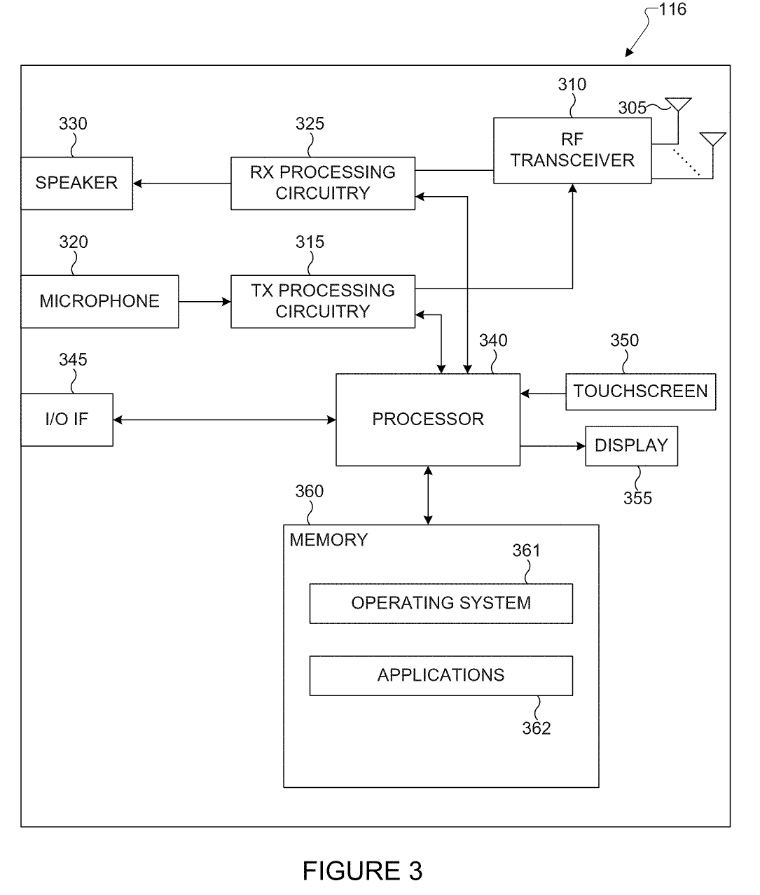

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by an eNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

In at least some embodiments, the RF transceiver 310 is capable of receiving, from a base station (BS) over a first downlink channel, a neighbor cell list comprising at least one neighbor cell. In at least some embodiments, the RF transceiver 310 is capable of transmitting the measured RSRP of the RS to the BS over the uplink channel. In at least some embodiments, the RF transceiver 310 is capable of receiving, from the BS, configuration information including first discovery RS information over the first downlink channel and transmitting, to at least one neighbor UE, a first discovery RS based on the configuration information received from the BS over the first downlink channel. In at least some embodiments, the RF transceiver 310 is capable of transmitting information indicating the identified uplink-to-downlink interference to the BS. In at least some embodiments, the RF transceiver 310 is capable of receiving information for a clear channel assessment (CCA) operation from the BS for an uplink transmission by the UE. In at least some embodiments, the RF transceiver 310 is capable of transmitting a first uplink transmission using the uplink transmission based on a result of the determination. In at least some embodiments, the RF transceiver 310 is capable of transmitting the second uplink transmission based on the adjusted TB size at an end of a transmit time interval (TTI), and wherein a portion of the second uplink transmission located in the TTI is equal to or smaller than a first uplink transmission by the at least one neighbor UE located in the TTI. The channel is measured to detect the uplink transmission will cause uplink-to-downlink interference to a downlink transmission to at least one neighbor UE.

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from eNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

In at least some embodiments, the processor 340 is also capable of measuring a reference signal received power (RSRP) of a reference signal (RS) received from the at least one neighbor cell included in the neighbor cell list and generating an indication based on the measured RSRP of the RS that is compared with a first threshold configured by the BS, wherein the transceiver is further configured to transmit the indication to the BS over an uplink channel. In at least some embodiments, the processor 340 is also capable of determining uplink-to-downlink interference based on the measured RSRP of the RS received from the at least one neighbor cell included in the neighbor cell list. In at least some embodiments, the processor 340 is also capable of measuring a second discovery RS received from the at least one neighbor UE and identifying uplink-to-downlink interference based on the measured second discovery RS received from the at least one neighbor UE. In at least some embodiments, the processor 340 is also capable of measuring signal energy of a channel for the uplink transmission and determining whether to adjust a length of the uplink transmission based on a result of the measurement. In at least some embodiments, the processor 340 is also capable of determining whether the CCA operation is available based on a second threshold that is configured by the BS. In at least some embodiments, the processor 340 is also capable of adjusting a transport block (TB) size of a second uplink transmission when the uplink-to-downlink interference is detected. The channel is measured to detect the uplink transmission will cause uplink-to-downlink interference to a downlink transmission to at least one neighbor UE.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 300 illustrates the UE 116 configured as a mobile telephone or smartphone, UEs could be configured to operate as other types of mobile or stationary devices.

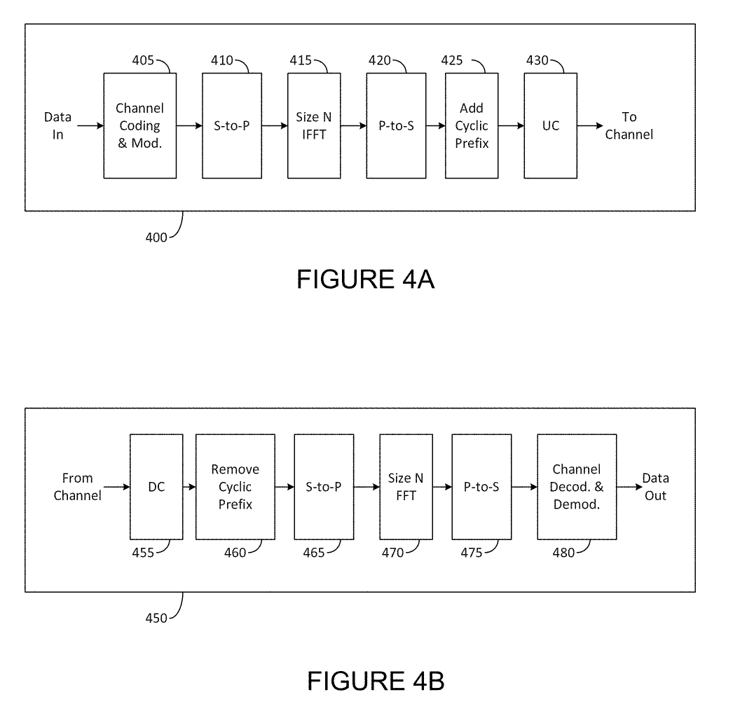

FIG. 4A is a high-level diagram of transmit path circuitry. For example, the transmit path circuitry may be used for an orthogonal frequency division multiple access (OFDMA) communication. FIG. 4B is a high-level diagram of receive path circuitry. For example, the receive path circuitry may be used for an orthogonal frequency division multiple access (OFDMA) communication. In FIGS. 4A and 4B, for downlink communication, the transmit path circuitry may be implemented in a base station (eNB) 102 or a relay station, and the receive path circuitry may be implemented in a user equipment (e.g. user equipment 116 of FIG. 1). In other examples, for uplink communication, the receive path circuitry 450 may be implemented in a base station (e.g. eNB 102 of FIG. 1) or a relay station, and the transmit path circuitry may be implemented in a user equipment (e.g. user equipment 116 of FIG. 1).

Transmit path circuitry comprises channel coding and modulation block 405, serial-to-parallel (S-to-P) block 410, Size N Inverse Fast Fourier Transform (IFFT) block 415, parallel-to-serial (P-to-S) block 420, add cyclic prefix block 425, and up-converter (UC) 430. Receive path circuitry 450 comprises down-converter (DC) 455, remove cyclic prefix block 460, serial-to-parallel (S-to-P) block 465, Size N Fast Fourier Transform (FFT) block 470, parallel-to-serial (P-to-S) block 475, and channel decoding and demodulation block 480.

At least some of the components in FIGS. 4A and 4B may be implemented in software, while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by discrete Fourier transform (DFT) functions and inverse discrete Fourier transform (IDFT) functions, respectively. It will be appreciated that for DFT and IDFT functions, the value of the N variable may be any integer number (i.e., 1, 4, 3, 4, etc.), while for FFT and IFFT functions, the value of the N variable may be any integer number that is a power of two (i.e., 1, 2, 4, 8, 16, etc.).

In transmit path circuitry 400, channel coding and modulation block 405 receives a set of information bits, applies coding (e.g., LDPC coding) and modulates (e.g., quadrature phase shift keying (QPSK) or quadrature amplitude modulation (QAM)) the input bits to produce a sequence of frequency-domain modulation symbols. Serial-to-parallel block 410 converts (i.e., de-multiplexes) the serial modulated symbols to parallel data to produce N parallel symbol streams where N is the IFFT/FFT size used in BS 102 and UE 116. Size N IFFT block 415 then performs an IFFT operation on the N parallel symbol streams to produce time-domain output signals. Parallel-to-serial block 420 converts (i.e., multiplexes) the parallel time-domain output symbols from Size N IFFT block 415 to produce a serial time-domain signal. Add cyclic prefix block 425 then inserts a cyclic prefix to the time-domain signal. Finally, up-converter 430 modulates (i.e., up-converts) the output of add cyclic prefix block 425 to RF frequency for transmission via a wireless channel. The signal may also be filtered at baseband before conversion to RF frequency.

The transmitted RF signal arrives at UE 116 after passing through the wireless channel, and reverse operations to those at eNB 102 are performed. Down-converter 455 down-converts the received signal to baseband frequency, and remove cyclic prefix block 460 removes the cyclic prefix to produce the serial time-domain baseband signal. Serial-to-parallel block 465 converts the time-domain baseband signal to parallel time-domain signals. Size N FFT block 470 then performs an FFT algorithm to produce N parallel frequency-domain signals. Parallel-to-serial block 475 converts the parallel frequency-domain signals to a sequence of modulated data symbols. Channel decoding and demodulation block 480 demodulates and then decodes the modulated symbols to recover the original input data stream.

Each of eNBs 101-103 may implement a transmit path that is analogous to transmitting in the downlink to user equipment 111-116 and may implement a receive path that is analogous to receiving in the uplink from user equipment 111-116. Similarly, each one of user equipment 111-116 may implement a transmit path corresponding to the architecture for transmitting in the uplink to eNBs 101-103 and may implement a receive path corresponding to the architecture for receiving in the downlink from eNBs 101-103.

Various embodiments of the present disclosure provides for a high-performance, scalability with respect to the number and geometry of transmit antennas, and a flexible CSI feedback (e.g., reporting) framework and structure for LTE enhancements when FD-MIMO with large two-dimensional antenna arrays is supported. To achieve high performance, more accurate CSI in terms MIMO channel is needed at the eNB especially for FDD scenarios. In this case, embodiments of the present disclosure recognize that the previous LTE (e.g. Rel.12) precoding framework (PMI-based feedback) may need to be replaced. In this disclosure, properties of FD-MIMO are factored in for the present disclosure. For example, the use of closely spaced large 2D antenna arrays that is primarily geared toward high beamforming gain rather than spatial multiplexing along with relatively small angular spread for each UE. Therefore, compression or dimensionality reduction of the channel feedback in accordance with a fixed set of basic functions and vectors may be achieved. In another example, updated channel feedback parameters (e.g., the channel angular spreads) may be obtained at low mobility using UE-specific higher-layer signaling. In addition, a CSI reporting (feedback) may also be performed cumulatively.

Another embodiment of the present disclosure incorporates a CSI reporting method and procedure with a reduced PMI feedback. This PMI reporting at a lower rate pertains to long-term DL channel statistics and represents a choice of a group of precoding vectors recommended by a UE to an eNB. The present disclosure also includes a DL transmission scheme wherein an eNB transmits data to a UE over a plurality of beamforming vectors while utilizing an open-loop diversity scheme. Accordingly, the use of long-term precoding ensures that open-loop transmit diversity is applied only across a limited number of ports (rather than all the ports available for FD-MIMO, e.g., 64). This avoids having to support excessively high dimension for open-loop transmit diversity that reduces CSI feedback overhead and improves robustness when CSI measurement quality is questionable.

It is essential that any cellular communications system is able to transmit in both directions simultaneously. This enables conversations to be made, with either end being able to talk and listen as required. Additionally when exchanging data it is necessary to be able to undertake virtually simultaneous or completely simultaneous communications in both directions. The transmission from UE to eNB is defined as an uplink and the transmission from the eNB to the UE is defined as a downlink. In order to transmit in both uplink and downlink, a UE and eNB have a duplex scheme. There are two forms of duplex scheme that are commonly used, namely frequency division duplexing (FDD) and time division duplex (TDD).

In a TDD system, a radio channel is shared between transmission and reception, spacing them apart by multiplexing the two signals on a time basis and transmitting a short burst of data in each direction.

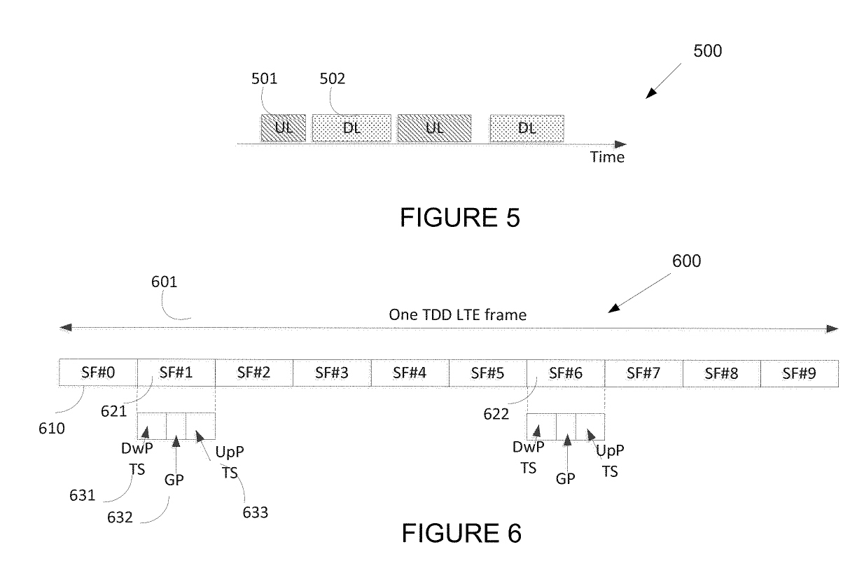

FIG. 5 illustrates a time-division duplexing (TDD) scheme 500 according to embodiments of the present disclosure. The embodiment of the TDD scheme 500 illustrated in FIG. 5 is for illustration only, and TDD scheme 500 of FIG. 5 could have the same or similar configuration. However, the TDD scheme 500 comes in a wide variety of configurations, and FIG. 5 does not limit the scope of this disclosure to any particular implementation of a TDD scheme. As illustrated in FIG. 5, the radio channel resources are divided in time. A DL transmission 502 and UL transmission 501 are multiplexed on the same radio channel on a time basis.

The 3^{rd} generation partnership long term evolution (3GPP LTE) specification has been designed to support both FDD and TDD scheme in a single specification. One type of LTE frame structure is a TDD. A total of frame duration is 10 milliseconds (ms) and there are totally 10 subframes in a frame.

FIG. 6 illustrates a TDD frame structure 600 according to embodiments of the present disclosure. The embodiment of the TDD frame structure 600 illustrated in FIG. 6 is for illustration only, and the TDD frame structure 600 of FIG. 6 could have the same or similar configuration. However, TDD frame structure 600 comes in a wide variety of configurations, and FIG. 6 does not limit the scope of this disclosure to any particular implementation of a TDD frame structure.

As shown in FIG. 6, a TDD LTE frame structure comprises one LTE TDD frame 601 that is divided into 10 subframes 610 (e.g., numbered from SF #0 to SF #9). Each subframe could be configured as a downlink subframe, an uplink subframe, or a special subframe. A subframe #1 621 is configured as a special subframe, which carries a DwPTS (downlink pilot time slot) 631, GP (guard period) 632 and UpPTS (uplink pilot time slot) 633. A subframe #6 622 could also be configured as special subframe in some TDD configuration defined LTE.

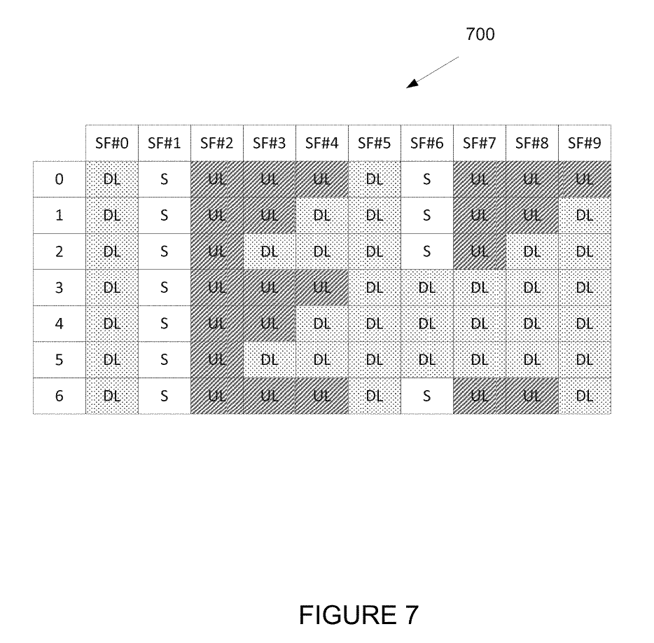

FIG. 7 illustrates a TDD configuration 700 according to embodiments of the present disclosure. The embodiment of the TDD configuration 700 illustrated in FIG. 7 is for illustration only, and the TDD configuration 700 of FIG. 7 could have the same or similar configuration. However, the TDD configuration 700 comes in a wide variety of configurations, and FIG. 7 does not limit the scope of this disclosure to any particular implementation of a TDD configuration. The TDD LTE specification defines 7 different TDD patterns with different downlink, uplink and special subframe configuration as illustrated in FIG. 7.

The subframe configuration is based on uplink downlink configuration 0-6 in FIG. 7. These 7 configurations provide (e.g., 0-6) different downlink and uplink ratio. The uplink and downlink ratio varies from approximately 60:40 to 10:90.

In one embodiment, a base station (BS) can provide wireless access services to one or more UEs. The downlink and uplink transmission between the BS and UEs are multiplexed through a TDD scheme. The BS could change a ratio of downlink and uplink in a TDD configuration dynamically. For example, the BS allocates more time resource to the downlink transmission than to the uplink transmission when there is more arriving downlink traffic than arriving uplink traffic.

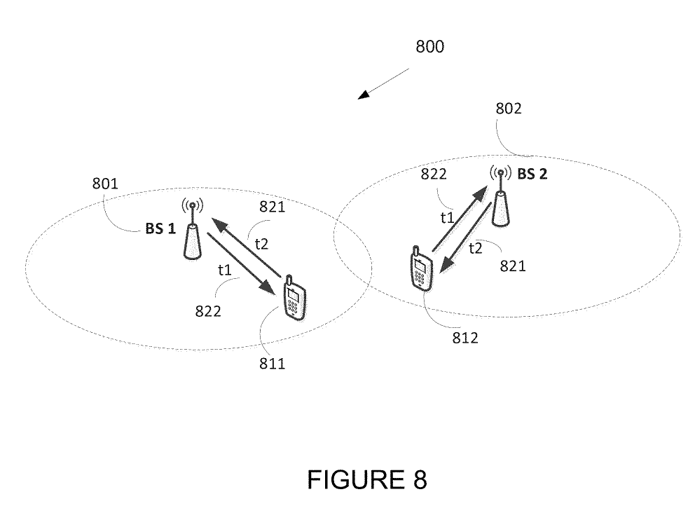

FIG. 8 illustrates a dynamic TDD wireless system 800 according to embodiments of the present disclosure. The embodiment of the dynamic TDD wireless system 800 illustrated in FIG. 8 is for illustration only, and the dynamic TDD wireless system 800 of FIG. 8 could have the same or similar configuration. However, dynamic TDD wireless system 800 comes in a wide variety of configurations, and FIG. 8 does not limit the scope of this disclosure to any particular implementation of a dynamic TDD wireless system.

Referring to FIG. 8, a BS 801 is configured to serve a UE 811 and a BS 802 is configured to serve a UE 812. The downlink and uplink transmission between the BS and UE is multiplexed through a TDD scheme. The downlink and uplink transmission partition in the BS 801 and 802 is not synchronized. Referring to FIG. 8, the BS1 801 transmits a downlink burst to the UE 811 in time period t1 822 while the BS2 802 receives a uplink burst from the UE 812 in time period t1 822. The BS1 801 receives the uplink burst from the UE 811 in the time period t2 821 while the BS2 802 transmits the downlink burst to the UE 812 in the time period t2 821.

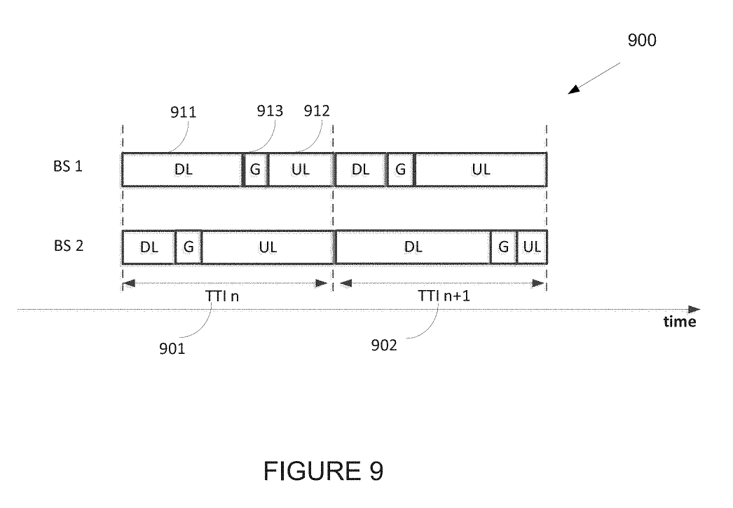

FIG. 9 illustrates a frame structure of dynamic TDD wireless system 900 according to embodiments of the present disclosure. The embodiment of the frame structure of dynamic TDD wireless system 900 illustrated in FIG. 9 is for illustration only, and the frame structure of dynamic TDD wireless system 900 of FIG. 9 could have the same or similar configuration. However, frame structure of dynamic TDD wireless system comes in a wide variety of configurations, and FIG. 9 does not limit the scope of this disclosure to any particular implementation of a frame structure of dynamic TDD wireless system.

FIG. 9 illustrates a frame structure of transmission in a BS1 801 and a BS2 802. Referring to FIG. 9, a TTI length and boundary in the BS1 801 and BS2 802 are aligned. One TTI has three portions. The first portion in one TTI is DL portion 911, during which the BS transmits a downlink burst to a UE. The third portion in one TTI is UL portion 912, during which the BS receives an uplink burst from the UE. Between the DL portion 911 and UL portion 912, there is a guard interval 913 for the DL-UL transmission switching. The partition of DL and UL of each BS could vary in each TTI. Referring to FIG. 9, the BS1 has a long DL 911 and a short UL in TTI n 901. But in TTI n+1 902, the BS 1 changes TTI partition to a short DL portion and a long UL portion.

In some embodiment, the DL and UL partition in each TTI in BS1 801 and BS2 802 are not same. Referring to the example in FIG. 9, in TTI n 901, the BS1 has a long DL portion and a UL portion 912 (e.g., short UL portion) but the BS2 has a short DL portion and a long UL portion.

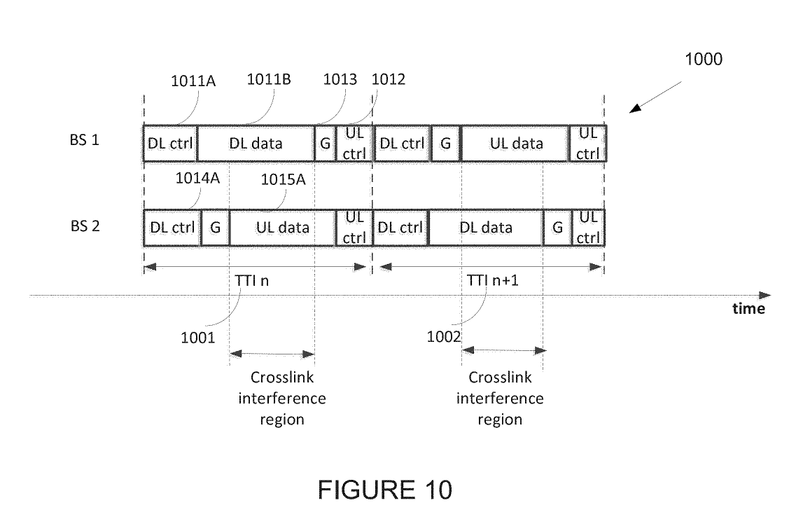

FIG. 10 illustrates another frame structure of dynamic TDD wireless system 1000 according to embodiments of the present disclosure. The embodiment of the frame structure of dynamic TDD wireless system 1000 illustrated in FIG. 10 is for illustration only, and the frame structure of dynamic TDD wireless system 1000 of FIG. 10 could have the same or similar configuration. However, a frame structure of dynamic TDD wireless system comes in a wide variety of configurations, and FIG. 10 does not limit the scope of this disclosure to any particular implementation of a frame structure of dynamic TDD wireless system 1000.

FIG. 10 illustrates another example of the frame structure of transmission in the BS1 801 and BS2 802. Referring to FIG. 10, a DL region is divided into a DL control region and a DL data region. The DL control regions of the different cells are aligned in time (1011A & 1014A) such that there is no cross-link interference. Similarly, the UL control regions of the different cells are aligned in time such that there is no cross-link interference. In this case, only the DL data region (1011B) and UL data region (1015A) can be impacted by the cross-link interference. In addition, the BS 1 and BS 2 comprise a TTI n 1001 and a TTI n+1 1002, respectively.

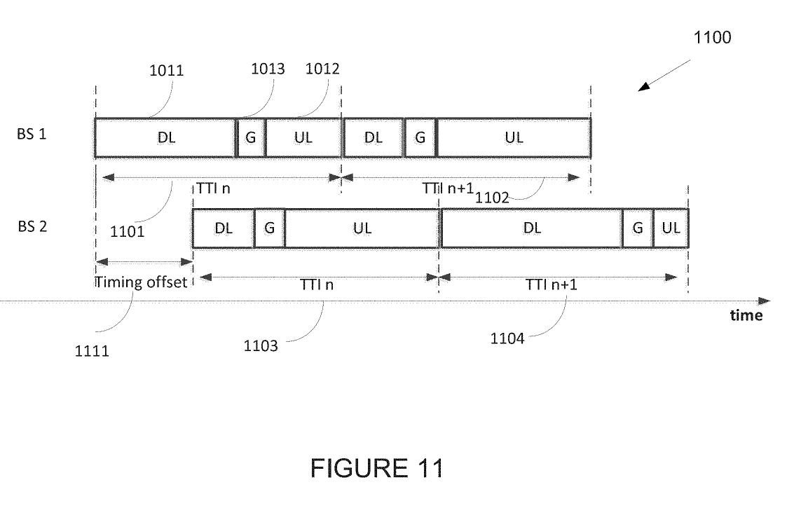

FIG. 11 illustrates yet another frame structure of dynamic TDD wireless system 1100 according to embodiments of the present disclosure. The embodiment of the frame structure of dynamic TDD wireless system 1100 illustrated in FIG. 11 is for illustration only, and the frame structure of dynamic TDD wireless system 1100 of FIG. 11 could have the same or similar configuration. However, a frame structure of dynamic TDD wireless system 1100 comes in a wide variety of configurations, and FIG. 11 does not limit the scope of this disclosure to any particular implementation of a frame structure of dynamic TDD wireless system.

In some embodiments, a BS could adjust the length of guard interval 1013 based on the cell loading. If the cell loading is light, the BS could choose a large guard interval. If the cell loading is heavy, the BS could choose a small guard interval. One motivation is to try to concentrate the DL portion to the beginning of one TTI and concentrate the UL portion to the end of one TTI to minimize the DL-UL collision between neighbor cells.

In some embodiments, the boundary of TTIs of multiple BSs is not aligned. An example is illustrated in FIG. 11. Referring to FIG. 11, the BS1 and BS2 have the same TTI length. There exists timing offset 1111 between TTI n 1101 of BS1 and TTI n 1103 of BS2. At each BS, the DL and UL partition could be varied in every TTI.

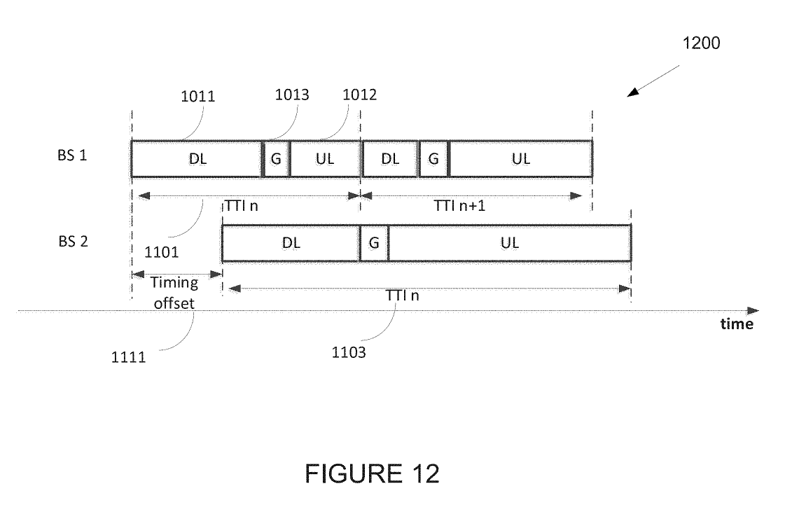

FIG. 12 illustrates yet another frame structure of dynamic TDD wireless system 1200 according to embodiments of the present disclosure. The embodiment of the frame structure of dynamic TDD wireless system 1200 illustrated in FIG. 12 is for illustration only, and the frame structure of dynamic TDD wireless system 1200 of FIG. 12 could have the same or similar configuration. However, a frame structure of dynamic TDD wireless system comes in a wide variety of configurations, and FIG. 12 does not limit the scope of this disclosure to any particular implementation of a frame structure of dynamic TDD wireless system.

In some embodiment, a boundary and length of TTI of multiple BSs are not aligned. An example is illustrated in FIG. 12. Referring to FIG. 12, the TTI length of BS1 is different from the TTI length of BS2. There also exists timing offset 1111 between TTI n 1101 of BS1 and TTI n 1103 of BS2.

In some embodiments, a BS could determine the BS's DL, UL and guard interval partition according deployment scenario and traffic of the BS. In one example, guard interval based on the size of coverage area size of the BS and the propagation delay of the transmission between BS and UEs is determined. The guard interval size may be long enough to accommodate variation in propagation delay of UEs that the BS is serving.

In one example, the DL and UL ratio in one TTI is determine to partition DL/UL based on the average traffic demanding rate. If the DL and UL traffic arrival rate of UE u are y_u (DL) and y_u (UL), respectively. Then the time allocated to downlink is given by:

$${T}_{DL} = {argmin}_{t} \vert \frac{{\sum }_{u} {γ}_{u} ( DL )}{{T}_{DL}} - \frac{{\sum }_{u} {γ}_{u} ( UL )}{T - {T}_{DL}} \vert$$

Where T is the total time available for DL and UL data transmission in one TTI. The time allocated to the uplink transmission in one TTI is T-T_DL. In one example, the DL/UL ratio is chosen in proportion to the average DL and UL traffic demand rate.

In some embodiments, DL/UL ratio is determined based on the data buffer size of DL and UL traffic. If the DL and UL data buffer size of one UE u is ω_u (DL) and ω_u (UL), respectively, the time allocated to downlink transmission is given by:

$${T}_{DL} = {argmin}_{t} \vert \frac{{\sum }_{u} {ω}_{u} ( DL )}{{T}_{DL}} - \frac{{\sum }_{u} {ω}_{u} ( UL )}{T - {T}_{DL}} \vert$$

In one example, the DL/UL ratio is chosen in proportion to the instantaneous traffic demand in downlink and uplink transmission.

The unsynchronized DL/UL partition between neighbor BSs may introduce a new type of interference from the BS transmitting in the opposite direction. This is referred to as cross-link interference. There are two types of cross-link interference: UL-to-DL interference and DL-to-UL interference.

It is noted that besides dynamic TDD, uncoordinated TDD configurations among neighboring cells or TRPs can also cause cross-link interference, even though the TDD configuration of each cell or TRP does not change dynamically. In one embodiment, uncoordinated TDD configurations among neighboring cells or TRPs are determined based on the aforementioned embodiments.

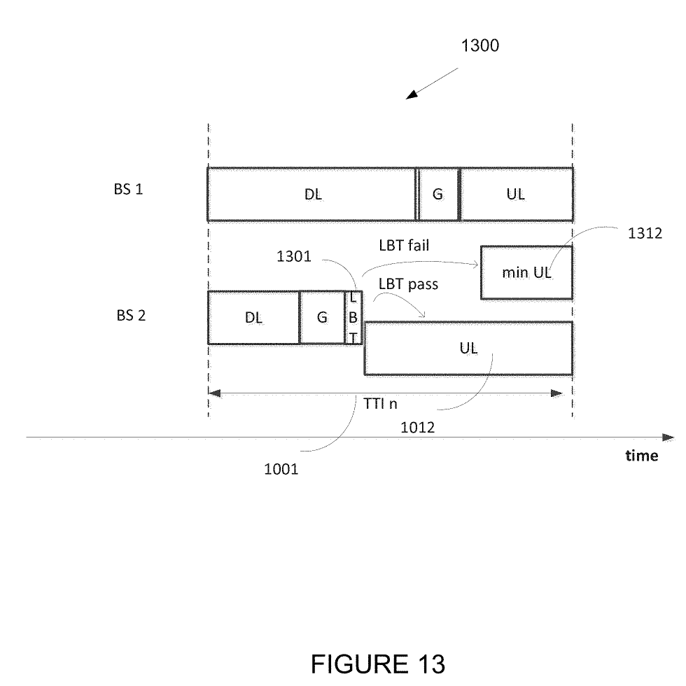

FIG. 13 illustrates a transmission scheme on listen-before-talk (LBT) mechanism 1300 according to embodiments of the present disclosure. The embodiment of the transmission scheme on the LBT mechanism 1300 illustrated in FIG. 13 is for illustration only, and the transmission scheme on the LBT mechanism 1300 of FIG. 13 could have the same or similar configuration. However, a transmission scheme on the LBT mechanism 1300 come in a wide variety of configurations, and FIG. 13 does not limit the scope of this disclosure to any particular implementation of a transmission scheme on listen-before-talk (LBT) mechanism.

A transmission scheme based on an LBT mechanism is illustrated in FIG. 13. Referring to FIG. 13, a BS2 schedules a UE to transmit an uplink burst. Before the uplink transmission, the UE conducts an LBT 1301 through clear channel assessment. The sensing duration can be a portion of the guard period or the whole of the guard period (not including the time required by the UE RF to perform Rx-to-Tx switching). If the clear channel assessment passes, the UE transmits the uplink burst as scheduled in an uplink portion 1012. If the clear channel assessment fails, the UE adjusts the TB size and transmits the uplink burst in a minimal uplink portion. The minimal uplink portion is an uplink portion with small duration at the one TTI. The size of minimal uplink portion ensures that there is no overlap between this uplink portion and downlink portion in neighbor cells.

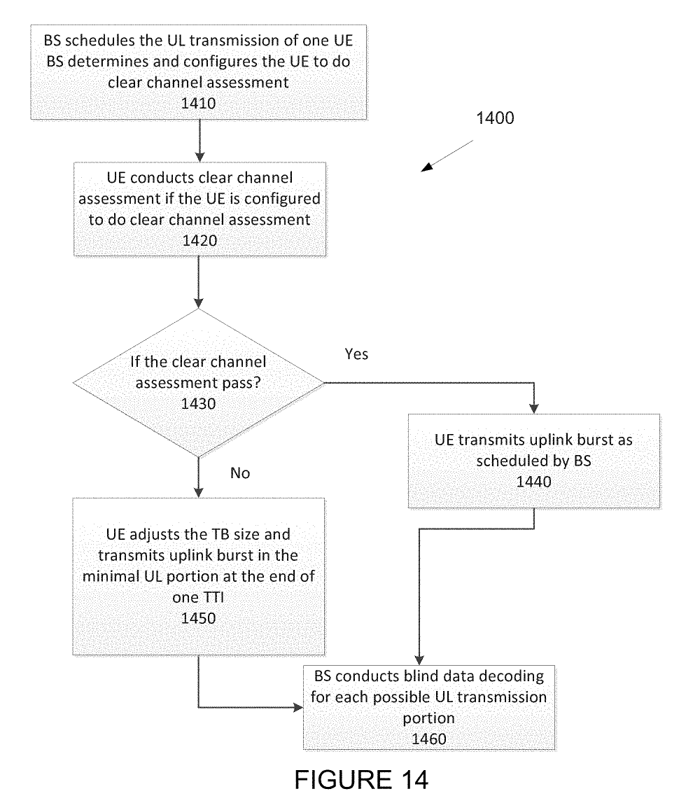

FIG. 14 illustrates protocol procedures 1400 according to embodiments of the present disclosure. The embodiment of the protocol procedures 1400 illustrated in FIG. 14 is for illustration only, and the protocol procedures 1400 of FIG. 14 could have the same or similar configuration. However, protocol procedures 1400 come in a wide variety of configurations, and FIG. 14 does not limit the scope of this disclosure to any particular implementation of protocol procedures.

To enable the aforementioned LBT-based transmission, there is a need for a protocol or procedure between the BS and the UE. As illustrated in FIG. 14, at step 1410, a BS schedules an uplink transmission for one UE. The BS also determines whether the UE may perform clear channel assessment or not. For example, the BS could determine the clear channel assessment of the UE based on the location of UE and configure the UE close to cell boundary to perform clear channel assessment before the uplink transmission. In one example, the BS could determine the aforementioned procedure based on a report that indicates that the UE's transmission can cause harmful interference, such as the report obtained as a result of the UL-to-DL interference procedure. At step 1410, if the BS determines that the UE may perform clear channel assessment, the BS signals the UE. The configuration of clear channel assessment could be sent in one downlink channel information (DCI) in physical downlink control channel (PDCCH) (e.g. in the DCI for UL grant), higher layer messages (e.g., radio resource control (RRC) message, or MAC control element (MAC CE)).

At step 1420, after the UE receives the uplink scheduling information, the UE conducts clear channel assessment according the configuration. In one example of clear channel assessment, the UE measures the signal energy in the radio channel (time-domain resource, e.g. slot/subframe, or time-frequency resources, e.g. the physical resource blocks) where this UE are scheduled for the uplink transmission. If the signal energy is above some thresholds (which can be predefined or configured by the network), the clear channel assessment fails. Otherwise, the clear channel assessment passes. At step 1430, the UE conducts corresponding action according to the results of clear channel assessment. At step 1440, if the clear channel assessment passes, the UE transmits the uplink bursts as originally scheduled by the BS. At step 1450, if the clear channel assessment fails, the UE transmits the uplink burst in a pre-defined minimal or smaller uplink portion or a pre-configured uplink portion in the TTI and adjusts the TB size accordingly. The minimal or smaller uplink portion could be configured by PDCCH message or some high layer message, like an RRC message. The configuration of minimal or smaller uplink portion includes the location and length of one uplink portion. In another example, the minimal or smaller uplink portion comprises a few orthogonal frequency division multiplexing (OFDM) symbols at the end of each TTI. At step 1460, the BS receives the uplink burst by blindly decoding all possible transmission portions for both clear channel assessment results.

At step 1450, the UE adjusts the TB size by performing scaling to the indicated TB size by the network (e.g. in the UL grant). In one example, the scaling is performed linearly proportionally to the ratio of the number of OFDM symbols for the minimal UL portion and the originally assigned number of OFDM symbols for UL data transmission. If the number of time-domain symbols (e.g. OFDM symbols) for the minimal UL portion is X and the originally assigned number of OFDM symbols for UL data transmission is Y, then the scaling to the transport block size (TBS) is performed as X/Y multiplied by the originally assigned TBS. If there isn't enough time budget for the UE to prepare the UL transport block according to the channel sensing outcome, the UE can prepare the UL transport blocks of multiple sizes beforehand and select the appropriate transport block to transmit according to the channel sensing outcome.

In some embodiments, instead of the UE adjusting the TB size at step 1450 according to a predefined method, the BS can signal two TBS values (e.g. in the UL grant to the UE). In one example, one TBS value corresponds to UL data transmission if the channel sensing passes and the full number of time-domain symbols are used for UL data transmission. In another example, another TBS value corresponds to UL data transmission if the channel sensing fails and the smaller number of time-domain symbols are used for UL data transmission.

In some embodiments, the minimal UL portion (e.g., 1312) corresponds to the UL control region as illustrated in FIG. 10 and the UL data transmission is effectively dropped or abandoned by the UE. In such embodiments, there is no need to perform TBS scaling.

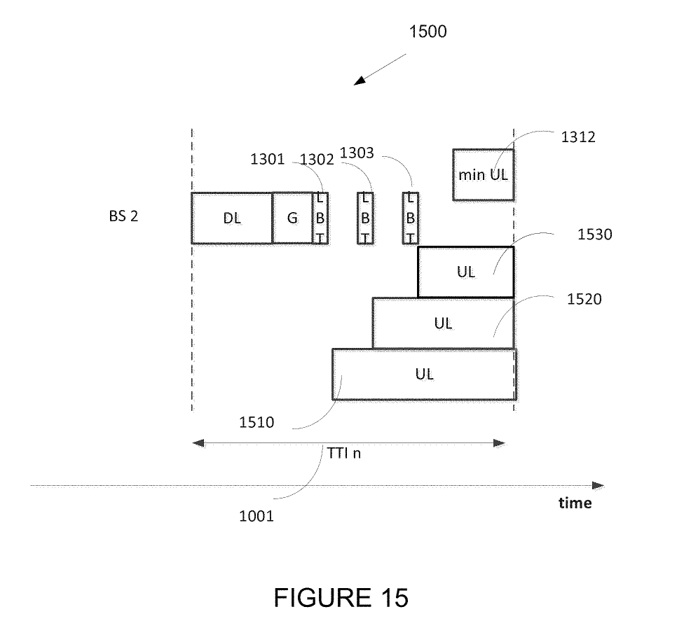

FIG. 15 illustrates a configuration of multiple LBT location 1500 according to embodiments of the present disclosure. The embodiment of the configuration of multiple LBT location 1500 illustrated in FIG. 15 is for illustration only, and the configuration of multiple LBT location 1500 of FIG. 15 could have the same or similar configuration. However, a configuration of multiple LBT location comes in a wide variety of configurations, and FIG. 15 does not limit the scope of this disclosure to any particular implementation of a configuration of multiple LBT location.

In some embodiments, a BS could configure multiple LBT locations for a UE to do clear channel assessment as illustrated in FIG. 15. Referring to the example in FIG. 15, a first LBT location 1301, a second LBT location 1302, and a third LBT location 1303 are configured. When being configured to this LBT configuration for uplink transmission, the UE first conducts clear channel assessment at the first LBT location 1301. If the clear channel assessment passes, the UE may transmit an uplink burst in the corresponding uplink portion 1510. If the clear channel assessment fails, the UE waits and conducts clear channel assessment in the second LBT location 1302. If the clear channel assessment passes, the UE may transmit uplink burst in the corresponding uplink portion 1520. If the clear channel assessment fails, the UE waits and conducts clear channel assessment in the third LBT location 1303. If the clear channel assessment passes, the UE may transmit an uplink burst in the corresponding uplink portion 1530. If the clear channel assessment fails at all LBT location, the UE transmits the uplink burst in minimal uplink portion 1312.

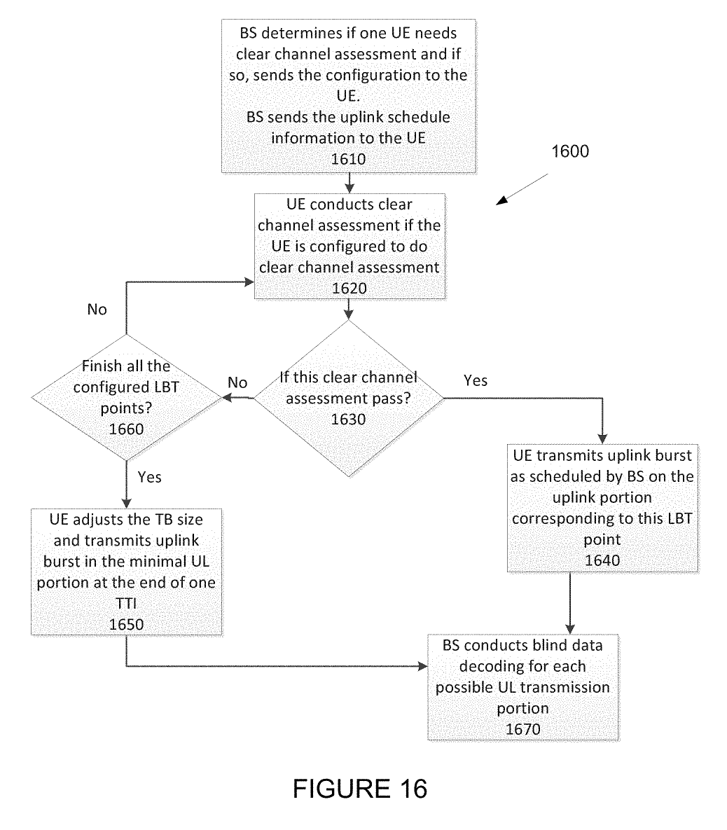

FIG. 16 illustrates another protocol procedure 1600 according to embodiments of the present disclosure. The embodiment of the protocol procedure 1600 illustrated in FIG. 16 is for illustration only, and the protocol procedure 1600 of FIG. 16 could have the same or similar configuration. However, a protocol procedure 1600 comes in a wide variety of configurations, and FIG. 16 does not limit the scope of this disclosure to any particular implementation of a protocol procedure.

The procedure between a BS and UE is illustrated in FIG. 16. At step 1610, the BS determines whether one UE needs clear channel assessment. If the BS determines the UE needs the channel assessment, the BS sends the LBT location configuration to the UE through, for example, high layer messages. The BS sends the uplink scheduling information to the UE. At 1620, the UE conducts the clear channel assessment in configured LBT location. At step 1630, the UE checks the results of clear channel assessment. If the result passes, at step 1640, the UE transmits the uplink burst in the corresponding uplink portion as scheduled. If the result fails, at step 1660, the UE checks if the UE completes all the configured LBT location. If so, the UE goes back to step 1620 and conducts clear channel assessment. At step 1660, if the UE completes all configured LBT points, the UE adjusts the TB size and transmits the uplink burst in a predefined minimal uplink portion in 1650. At step 1670, the BS decodes the uplink burst for all possible uplink portions based on the LBT configuration of the UE.

In some embodiments, there are other variations of the UE transmission behavior based on the channel sensing outcome. Instead of the changing the UL transmission duration (and the corresponding TBS) if channel is not sensed to be idle, the UE can transmit still with the same duration but with a lower power and potentially with a different TBS and multiple coding scheme (MCS) that is more suitable for the lower transmit power. In such embodiments, the interference incurred by the UE's UL transmission can be mitigated. The transmit power level can be pre-configured by a network through higher layer signaling, or the transmit power level can be inversely proportional to the energy level sensed by the UE through channel sensing.

In one example, multiple discrete transmit power levels or power scaling factors can be predefined or configured by the network (e.g. through higher layer signaling), and multiple thresholds for clear channel assessment or channel sensing can be predefined or configured by the network. A mapping between the transmit power of the UE (and other transmission properties such as the TBS and the MCS) and the threshold in which the channel is sensed to be busy can be defined, for example as illustrated in TABLE 1. As a special case, P1 in TABLE 1 can be set to zero which implies the UE may not transmit (or only transmit in the minimal duration or region that does not cause cross-link interference).

TABLE 1

| Threshold for CCA failure | |
|---|---|
| (energy detected > Threshold) | UE transmission procedure |
| Threshold 1 | Tx power level or scaling factor (P1) |
| Threshold 2 (>Threshold 1) | Tx power level or scaling factor (P2 > P1) |
| Threshold 3 (>Threshold 2) | Tx power level or scaling factor (P3 > P2) |

The aforementioned embodiments can also be applied to downlink transmission by the BS in a straightforward manner. In this case, the BS performs channel sensing before performing a downlink transmission that can cause cross-link interference. For the frame structure as illustrated in FIG. 10, the BS performs channel sensing before the downlink data channel (e.g. physical downlink shared channel (PDSCH)). One time-domain symbol between the DL control channel and the DL data channel is can be used for channel sensing purpose.

The downlink data channel transmission can be dropped or can be transmitted at a lower power depending in the energy level detected in a similar way as described for UL transmission. Further details are omitted for brevity. For the UE intending to receive the DL data transmission, the UE can perform detection of the presence of the DL data transmission based on, for example, DL demodulation reference signal (RS), in order to avoid hybrid automatic repeat request (HARQ) buffer corruption.

In one example, the aforementioned embodiments can also be applied to a sidelink transmission by a UE (to another UE) or a BS (to another BS) to mitigate cross-link interference between sidelink and downlink/uplink or another sidelink.

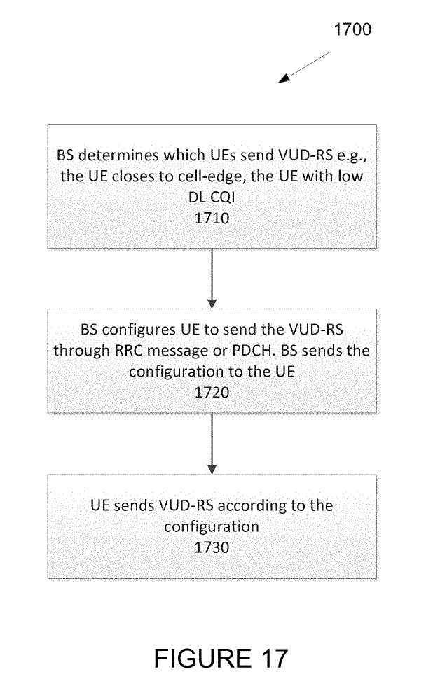

FIG. 17 illustrates a victim user equipment (UE) discovery-reference signal (VUD-RS) transmission method 1700 according to embodiments of the present disclosure. The embodiment of the VUD-RS transmission method 1700 illustrated in FIG. 17 is for illustration only, and the VUD-RS transmission method 1700 of FIG. 17 could have the same or similar configuration. However, a VUD-RS transmission method 1700 comes in a wide variety of configurations, and FIG. 17 does not limit the scope of this disclosure to any particular implementation of a VUD-RS transmission method.

In some embodiments, some UEs measure the specific RS transmitted by UEs in neighbor cell to detect the potential UL-to-DL interference link. This specific RS is termed as victim UE discovery RS (VUD-RS). The procedure for transmitting VUD-RS is illustrated in FIG. 17. At step 1710, a BS first determines which UEs may send the VUD-RS. For example, the BS could choose those UEs close to the cell boundary. At step 1720, the BS sends the VUD-RS configuration to the selected UEs using RRC messages. In one example, the configuration includes the number of TTI or subframe in which the UE should transmit the VUD-RS. In another example, the configuration includes the time and frequency location where the UE should transmit the VUD-RS in one TTI. In yet another example, the configuration includes the sequence used for the VUD-RS transmission. In yet another example, the configuration includes the transmission power. In another example, the configuration includes the timing advance used for the OFDM symbol which carries the VUD-RS.

The configuration of VUD-RS could be cell specific. In this case, the UEs configured by the same BS may transmit the same sequence in the same transmit time interval (TTI) and on the same time frequency location. The configuration of VUD-RS could be UE-specific. In this case, the BS formulates and sends the configuration for each individual UE.

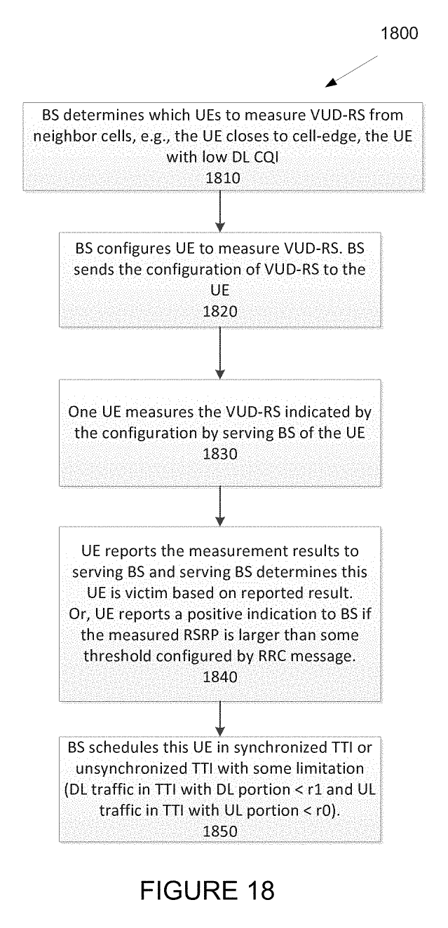

FIG. 18 illustrates a measurement method of VUD-RS transmission 1800 according to embodiments of the present disclosure. The embodiment of the measurement method of VUD-RS transmission 1800 illustrated in FIG. 18 is for illustration only, and the measurement method of VUD-RS transmission 1800 of FIG. 18 could have the same or similar configuration. However, a measurement method of VUD-RS transmission comes in a wide variety of configurations, and FIG. 18 does not limit the scope of this disclosure to any particular implementation of a measurement method of VUD-RS transmission.

A BS could also schedule some UEs to measure the VUD-RS transmitted by UEs in some neighbor cells to detect the potential UL-to-DL interference. The procedure is illustrated in FIG. 18. At step 1810, a BS first determines which UEs may measure the VUD-RS from some neighbor cells. The BS could select those UE with low downlink channel quality indication (CQI). At step 1820, the BS configures the UE to measure the VUD-RS from some neighbor cells and sends the configuration of target VUD-RS. In one example, the configuration of target VUD-RS could include the number of TTI or subframe. In another example, the configuration of target VUD-RS could include the frequency time location. In yet another example, the configuration of target VUD-RS could include the sequence of VUD-RS.

The BS could configure the UE to measure multiple VUD-RS configurations from multiple or single neighbor cell. In one example, the VUD-RS is cell-specific and the configuration of VUD-RS is associated with cell identifier (ID). The BS could send a list of target neighbor cells of that the UE may measure the VUD-RS. Then the UE could figure out the VUD-RS configuration based on the mapping between cell id and VUD-RS configuration.

As shown in FIG. 18, at step 1830, the UE measures the VUD-RS of neighbor cell(s) based on the configuration. In one example, the UE measures the reference signal received power (RSRP) of one VUD-RS. At step 1840, the UE reports the measurement results to the serving BS and then the serving BS determines whether the UE is a victim to UL-to-DL interference based on the reported results. At step 1840, the UE could determine if it is victim to UL-to-DL interference based on its measurement results. If the UE determines that the UE is a victim, the UE reports a positive notification to the serving BS. At step 1850, the BS schedules the victim UEs in synchronized TTI where there is no UL-to-DL interference or in the unsynchronized TTI but with DL portion less than some thresholds.

In one example, the VUD-RS is one or more existing UL physical signals such as UL demodulation RS associated with a physical channel (e.g. physical uplink shared channel (PUSCH) and/or physical uplink control channel (PUCCH)), SRS and PRACH. In another example, the VUD-RS is a UL physical signal designed for other purposes such as UL phase noise compensation. An advantage of defining VUD-RS to be an UL physical signal is that UE implementation for UL signal generation and transmission can be reused for the VUD-RS.

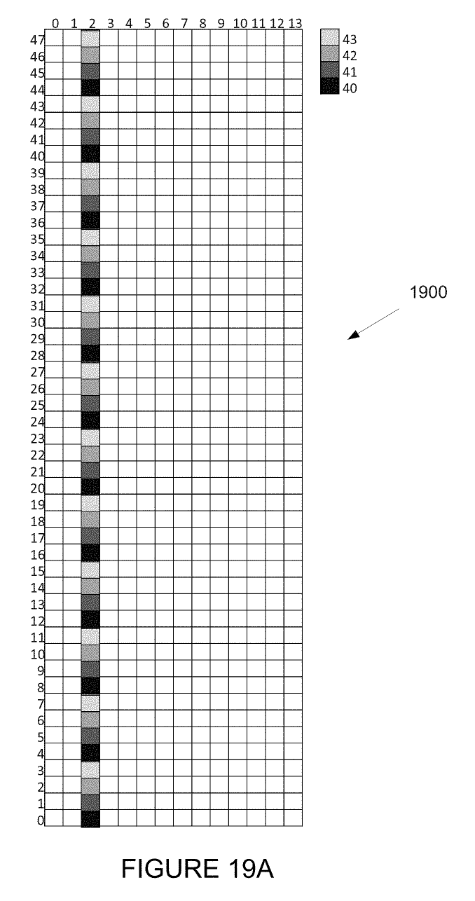

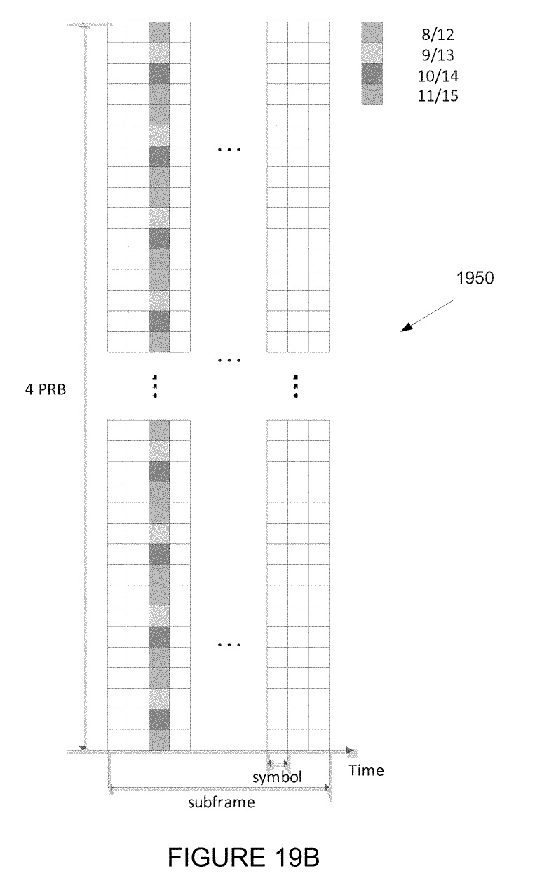

FIG. 19A illustrates an uplink demodulation-reference signal resource element (UL DM-RS RE) mapping 1900 according to embodiments of the present disclosure. The embodiment of the UL DM-RS RE mapping 1900 illustrated in FIG. 19A is for illustration only, and the UL DM-RS RE mapping 1900 of FIG. 19A could have the same or similar configuration. However, a UL DM-RS RE mapping comes in a wide variety of configurations, and FIG. 19A does not limit the scope of this disclosure to any particular implementation of a UL DM-RS RE mapping.

From a victim UE's and network's perspective, it is beneficial if the REs occupied by the VUD-RS are not interfered by other signals so that accurate detection and measurement of the VUD-RS can be performed by the victim UE. The REs occupied by the VUD-RS may overlap with the DL region of the victim UE. A measurement period can be configured to the potential victim UEs to perform such measurement. From the victim UE's and network's point of view, it is desirable for the VUD-RS to be multiplexed in an orthogonal manner with DL signals in a subframe or TTI to minimize the resource overhead or performance penalty from performing the VUD-RS detection and measurement. In such example, it is also advantageous that the DL and UL timings of neighboring cells are synchronized sufficiently to minimize inter-link interference. In such example, where the UL DM-RS is also used as VUD-RS, the examples UL DM-RS RE mapping and DL DM-RS RE mapping as illustrated in FIG. 19A can meet the requirement of orthogonal VUD-RS and DL DM-RS in the same subframe if the RSs assigned do not collide. For example, VUD-RS RE (or port) can be indicated (to the victim and the aggressor UEs) to be 40 in FIG. 19A, while the DL DM-RS RE or port to be received in the same subframe can be indicated (to the victim UE) to be port 8 as illustrated in FIG. 19B.

FIG. 19B illustrates a downlink demodulation-reference signal resource element (DL DM-RS RE) mapping 1950 according to embodiments of the present disclosure. The embodiment of the DL DM-RS RE mapping 1950 illustrated in FIG. 19B is for illustration only, and the DL DM-RS RE mapping 1950 of FIG. 19B could have the same or similar configuration. However, a DL DM-RS RE mapping 1950 comes in a wide variety of configurations, and FIG. 19B does not limit the scope of this disclosure to any particular implementation of a DL DM-RS RE mapping.

There is a need to signal the VUD-RS resource to the potential victim UEs. In one example, the VUD-RS resource information can be configured by the higher layer (e.g. RRC). The information can include the time and frequency resources for the VUD-RS resource (e.g. subframe offset with respect to a reference subframe defined by system frame number and the periodicity, resource element (RE)/port information), the information needed to generate the VUD-RS sequence (such as one or more IDs and scrambling parameters), and measurement reporting configuration. When the VUD-RS includes the same RS pattern as the DL/UL DM-RS or DL/UL PCRS, the VUD-RS can be called zero-power DL/UL DM-RS or zero-power DL/UL PCRS, respectively. Upon configuration of the VUD-RS resource, the potential victim UE performs detection and/or measurement of the VUD-RS accordingly.

In the case of dynamic TDD or uncoordinated TDD among neighboring cells/TRPs (i.e. a subframe with a particular subframe index can be either used for UL data transmission or DL data transmission), when the configured VUD-RS resource coincides with the UL region, then the UE doesn't perform VUD-RS detection and/or measurement. In another example, the trigger to detect and/or measure VUD-RS can be indicated dynamically through L1 signaling such as in a PDCCH (e.g. a UE-common (or UE-group common) DCI or a UE-specific DCI for DL assignment). The information indicated in the PDCCH can be the same as those described for higher layer signaling. In yet another example, the RRC configuration and L1 signaling can jointly indicate the VUD-RS resource. In yet another example, the RRC can configure the potential subframe set for VUD-RS measurement and the L1 signaling can indicate if a subframe within the set is activated for VUD-RS detection/measurement.

When the VUD-RS is the UL DM-RS, and the DL DM-RS includes the same RS pattern as the UL DM-RS, there is a need for the network or the UE to identify if the interference is from another UE's UL or another BS's DL. It can also be beneficial for the victim UE to identify if the interference is from the same BS's DL to another UE. In one embodiment, the sequence for VUD-RS is the same as that for DL DM-RS but is scrambled with an additional ID to indicate that it is not a DL DM-RS. The UE performing measurement can blindly detect which sequence is detected and report to the network if the detected sequence corresponds to the VUD-RS. In one embodiment, an orthogonal set of REs are reserved for VUD-RS, hence the UE can identify VUD-RS based on RE locations.

In addition, it can be beneficial for the network to identify the UE ID of the aggressor UE so that network coordination can be performed subsequently to resolve the cross-link interference problem. To this end, a set of possible aggressor UE IDs, or other IDs that can be used to identify the aggressor UE, can be signaled to the potential victim UEs (e.g. via RRC signaling). The potential victim UEs blindly detects the presence of one or more aggressor UEs and report the detected ID and the corresponding signal measurement results to the network. The BS that receives the report can forward the report to the serving BS of the aggressor UE to mitigate the cross-link interference.

For the aggressor UE, when the VUD-RS is a UL demodulation RS, the VUD-RS can be transmitted whenever the PUSCH is transmitted. However, it is beneficial if the transmission can be triggered without the associated PUSCH when there is no UL data to transmit. This can save the aggressor UE's power and avoid unnecessary UL interference. In one example, the VUD-RS transmission information can be configured by the higher layer (e.g. RRC). The information can include the time and frequency resources for the VUD-RS transmission (e.g. subframe offset with respect to a reference subframe defined by system frame number and the periodicity, RE/port information) and the information needed to generate the VUD-RS sequence (such as the ID). When the configured VUD-RS overlaps with a PUSCH transmission, then VUD-RS is simply the UL DM-RS with the corresponding PUSCH; else only the VUD-RS is transmitted (equivalently UL DM-RS without PUSCH).

In another example, the trigger to transmit VUD-RS can be indicated dynamically through L1 signaling such as in a PDCCH (e.g. a UE-common (or UE-group common) DCI or a UE-specific DCI). The information indicated in the PDCCH can be the same as those described for higher layer signaling. In yet another example, the RRC configuration and L1 signaling can jointly indicate the VUD-RS resource. In yet another example, the RRC can configure the potential subframe set for VUD-RS transmission and the L1 signaling can indicate if a subframe within the set is activated for VUD-RS transmission.

When a VUD-RS can be detected or signaled to the victim UE in a subframe or a TTI where the victim UE is also receiving a transmission such as PDSCH, the victim UE can estimate the channel of the interference channel if the UE is informed the information needed to regenerate the VUD-RS sequence. When the VUD-RS is the same as the UL DM-RS sequence and RE mapping, and there may or may not be an associated PUSCH, a 1-bit signaling can be provided in a dynamic control channel (e.g. the DL assignment DCI format) to assist the victim UE in determining if there is an associated UL physical channel transmitted by the aggressor UE. This enables the victim UE to decide if it can perform interference suppression and/or cancellation to improve the UE's DL data reception. For example, if it is indicated that there is no associated PUSCH, and then the victim UE doesn't perform interference suppression and/or cancellation, else the UE performs interference suppression and/or cancellation.

In yet another example, VUD-RS is a physical signal originally designed or specified to be transmitted by a BS, such as beam reference signal, DL demodulation signal, CSI-RS. An advantage of this example is that the signal reception and measurement implementations can be reused for the victim UE. The aforementioned signaling and configuration schemes can also be applied in this case and the descriptions are omitted for brevity.

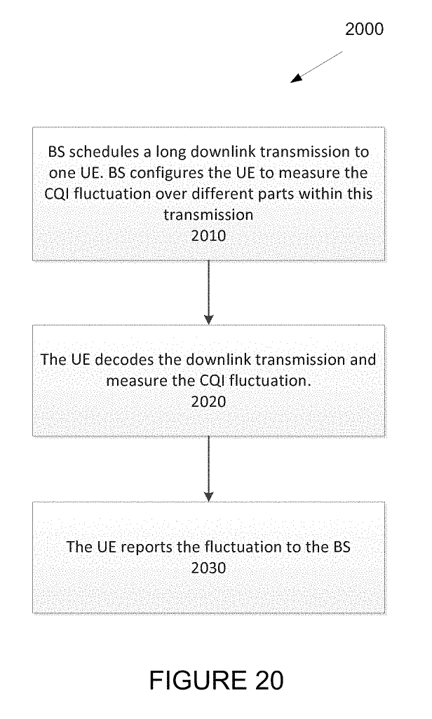

FIG. 20 illustrates a downlink transmission method 2000 according to embodiments of the present disclosure. The embodiment of the downlink transmission method 2000 illustrated in FIG. 20 is for illustration only, and the downlink transmission method 2000 of FIG. 20 could have the same or similar configuration. However, a downlink transmission method 2000 comes in a wide variety of configurations, and FIG. 20 does not limit the scope of this disclosure to any particular implementation of a downlink transmission method.

In some embodiments, the UE could determine if it is victim to UL-to-DL interference without measuring VUD-RS and then reports the UE's decision to the serving BS. In one example, a UE determines based on its downlink channel quality. The UE could detect the downlink CQI fluctuation over multiple TTIs. The UE could also check the downlink CQI fluctuation over different portions within one downlink burst. In another example, if the UE's downlink quality has big fluctuation, the UE reports a notification of victim UL-to-DL interference to the serving BS. The BS could configure the UE to conduct some measurement on the downlink and report the UE's decision.

In yet another example, the BS can examine the multiple instances of CQI reports and determine if the UE is a victim. As illustrated in FIG. 20, at step 2010, the BS schedules a long downlink transmission to the UE. The BS configures the UE to measure the CQI fluctuation over different parts within this transmission. At step 2020, the UE decodes the downlink transmission and the UE also measures the CQI fluctuation as being configured by the BS. At step 2030, the UE reports the measurement results to the BS. The BS then could determine if the UE is victim to UL-to-DL interference based on the reported results.

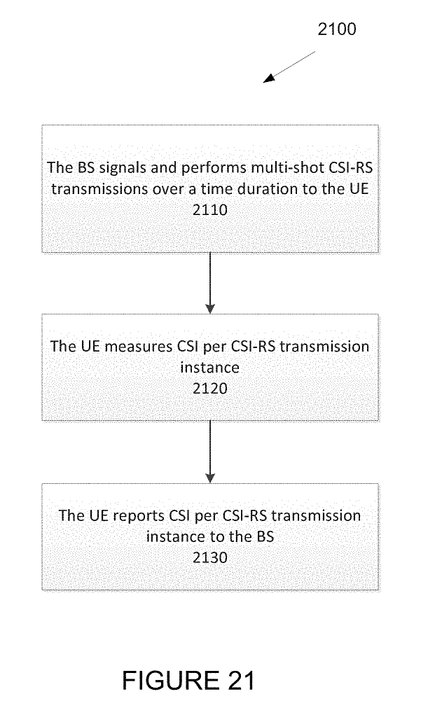

FIG. 21 illustrates a multi-shot channel state information-reference signal (CSI-RS) transmission 2100 according to embodiments of the present disclosure. The embodiment of the multi-shot CSI-RS transmission 2100 illustrated in FIG. 21 is for illustration only, and the multi-shot CSI-RS transmission 2100 of FIG. 21 could have the same or similar configuration. However, a multi-shot CSI-RS transmission comes in a wide variety of configurations, and FIG. 21 does not limit the scope of this disclosure to any particular implementation of a multi-shot CSI-RS transmission.

Referring to FIG. 21, the BS signals and performs multi-shot CSI-RS transmissions over time duration to the UE at step 2110. Multi-shot CSI-RS transmissions refers to transmission of CSI-RS in consecutive downlink subframes or in consecutive downlink regions (e.g. slot or a smaller unit) within a subframe. The signaling of multi-shot CSI-RS can be signaled by the network to the UE using a dynamic control channel such as a PDCCH. The UE then performs CSI measurement per CSI-RS transmission instance (no averaging across time instances) (e.g., 1420) and reports the corresponding CSIs to the network at step 2130. The network can then determine the presence of UL-to-DL interference based on the CSI reports. Although CSI-RS is used as the example here, other signals are not precluded. For example, in the UL, multi-shot sounding reference signal can be triggered by the BS so that the BS can measure the UL channel quality fluctuation to detect DL-to-UL interference.

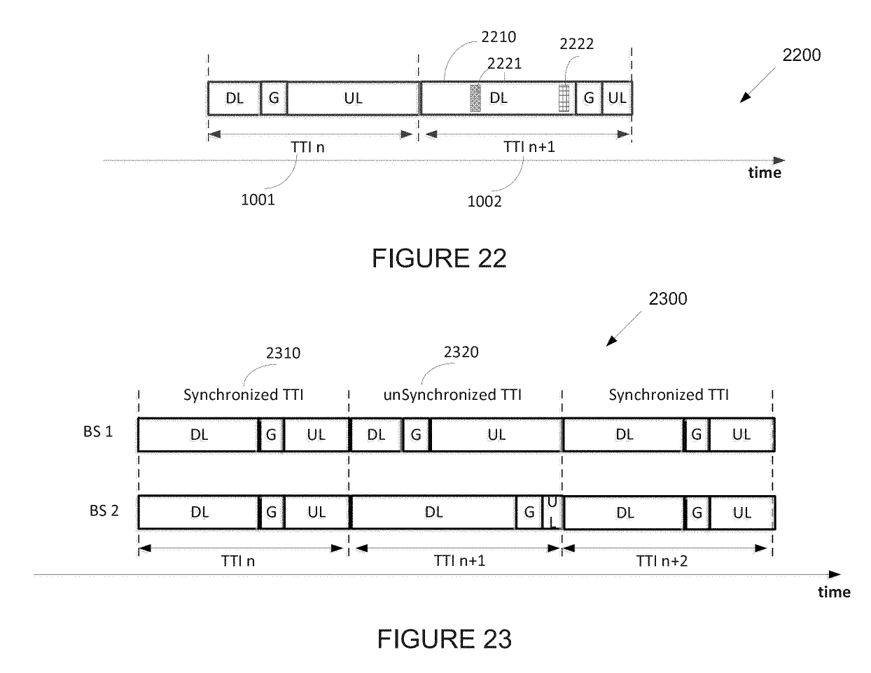

FIG. 22 illustrates a special downlink transmission for UL-to-DL measurement 2200 according to embodiments of the present disclosure. The embodiment of the special downlink transmission for UL-to-DL measurement 2200 illustrated in FIG. 22 is for illustration only, and the special downlink transmission for UL-to-DL measurement 2200 of FIG. 22 could have the same or similar configuration. However, a special downlink transmission for UL-to-DL measurement comes in a wide variety of configurations, and FIG. 22 does not limit the scope of this disclosure to any particular implementation of a special downlink transmission for UL-to-DL measurement.

In some embodiments, the BS sends one special multicast or broadcast downlink transmission to multiple UEs and configures multiple UEs to measure the fluctuation of CQI within this transmission. Such downlink transmission has special reference signal design so that the UE is able to measure the CQI of each of multiple parts in this transmission reliably. One example is that this downlink transmission is divided into few parts and reference signal is inserted in each part, and the UE is configured to use the reference signal in each part to measure the CQI of this part.

Special downlink transmission for UL-to-DL measurement is illustrated in FIG. 22. As illustrated in FIG. 22, a DL transmission 2210 is sent in TTI n+1 1002. A first special reference signal 2221 and a second special reference signal 2222 are inserted in the downlink transmission 2210. In one example, a first special reference signal 2221 is inserted close to the beginning of the DL portion and a second special reference signal 2222 is inserted close to the end of the DL portion. The UE is configured to measure the CQI of reference signal 2221 and 2222 separately and measure the differential between them.

FIG. 23 illustrates a transmit time interval (TTI) transmission 2300 according to embodiments of the present disclosure. The embodiment of the TTI transmission 2300 illustrated in FIG. 23 is for illustration only, and the TTI transmission 2300 of FIG. 23 could have the same or similar configuration. However, a TTI transmission comes in a wide variety of configurations, and FIG. 23 does not limit the scope of this disclosure to any particular implementation of a TTI transmission.

In some embodiment, the TTIs are divided into two types. In one example, TTI is synchronized where the neighbor cells share the same DL/UL partition and where there is no cross-link interference. In another example, TTI is unsynchronized where each BS is allowed to use the DL/UL partition different from that of neighbor cells. As illustrated in FIG. 23, TTI n is synchronized TTI 2310. In TTI n, the transmission of BS1 and BS2 share the same DL and UL configuration. TTI n+1 is unsynchronized TTI 2320. In TTI n+1, the transmission of BS1 and BS2 could use different DL and UL configuration.

In the aforementioned example, the BS could use the scheme of synchronized/unsynchronized TTI to protect the UE that is victim to cross-link interference. For example, the BS schedules the victim UE in synchronized TTIs and the BS schedules victim to UL-to-DL interference in the unsynchronized TTI with DL portion length less than some threshold.

Although the present disclosure has been described with an exemplary embodiment, various changes and modifications may be suggested to one skilled in the art. It is intended that the present disclosure encompass such changes and modifications as fall within the scope of the appended claims.

None of the description in this application should be read as implying that any particular element, step, or function is an essential element that must be included in the claims scope. The scope of patented subject matter is defined only by the claims. Moreover, none of the claims are intended to invoke 35 U.S.C. §112(f) unless the exact words “means for” are followed by a participle.

What is claimed is:

1. A user equipment (UE) in a wireless communication system, the UE comprising:
a transceiver configured to receive, from a base station (BS) over a first downlink channel, a neighbor cell list comprising at least one neighbor cell; and
at least one processor configured to:
measure a reference signal received power (RSRP) of a reference signal (RS) received from the at least one neighbor cell included in the neighbor cell list; and
generate an indication based on the measured RSRP of the RS that is compared with a first threshold configured by the BS,
wherein the transceiver is further configured to transmit the indication to the BS over an uplink channel.

2. The UE of claim 1, wherein:
the at least one processor is further configured to determine uplink-to-downlink interference based on the measured RSRP of the RS received from the at least one neighbor cell included in the neighbor cell list; and
the transceiver is further configured to transmit the measured RSRP of the RS to the BS over the uplink channel.

3. The UE of claim 1, wherein the transceiver is further configured to:
receive, from the BS, configuration information including first discovery RS information over the first downlink channel; and
transmit, to at least one neighbor UE, a first discovery RS based on the configuration information received from the BS over the first downlink channel.

4. The UE of claim 3, wherein:
the at least one processor is further configured to:
measure a second discovery RS received from the at least one neighbor UE; and
identify uplink-to-downlink interference based on the measured second discovery RS received from the at least one neighbor UE; and
the transceiver is further configured to transmit information indicating the identified uplink-to-downlink interference to the BS.

5. The UE of claim 1, wherein:
the transceiver is further configured to receive information for a clear channel assessment (CCA) operation from the BS for an uplink transmission by the UE; and
the at least one processor is further configured to:
measure signal energy of a channel for the uplink transmission; and
determine whether to adjust a length of the uplink transmission based on a result of the measurement.

6. The UE of claim 5, wherein:
the at least one processor is further configured to determine whether the CCA operation is available based on a second threshold that is configured by the BS; and
the transceiver is further configured to transmit a first uplink transmission using the uplink transmission based on a result of the determination of whether the CCA operation is available.

7. The UE of claim 5, wherein:
the channel is measured to detect the uplink transmission will cause uplink-to-downlink interference to a downlink transmission to at least one neighbor UE;
the at least one processor is further configured to adjust a transport block (TB) size of a second uplink transmission when the uplink-to-downlink interference is detected; and
the transceiver is further configured to transmit the second uplink transmission based on the adjusted TB size at an end of a transmit time interval (TTI), and
a portion of the second uplink transmission located in the TTI is equal to or smaller than a first uplink transmission by the at least one neighbor UE located in the TTI.

8. A base station (BS) in a wireless communication system, the BS comprising:
at least one processor configured to determine at least one user equipment (UE) among a plurality of UEs to measure a reference signal (RS) of at least one neighbor cell; and
a transceiver configured to:
transmit, to the at least one UE over a first downlink channel, a neighbor cell list comprising the at least one neighbor cell; and
receive, from the at least one UE, an indication including a measured reference signal received power (RSRP) of a reference signal (RS) received from the at least one neighbor cell included in the neighbor cell list based on a first threshold information configured by the BS.

9. The BS of claim 8, wherein the transceiver is further configured to receive uplink-to-downlink interference based on the measured RSRP of the RS received from the at least one neighbor cell included in the neighbor cell list.

10. The BS of claim 8, wherein the transceiver is further configured to transmit configuration information including first discovery RS information over the first downlink channel.

11. The BS of claim 8, wherein the at least one processor is further configured to schedule the at least one UE in at least one of a synchronized transmit time interval (TTI) or an asynchronized TTI.

12. The BS of claim 8, wherein:
the transceiver is further configured to:
transmit information for a clear channel assessment (CCA) operation to the at least one UE for an uplink transmission by the UE; and
receive the uplink transmission using a first uplink transmission when the CCA operation is available; and
the at least one processor is further configured to perform a blind data decoding for the received uplink transmission.

13. The BS of claim 12, wherein the transceiver is further configured to receive the uplink transmission based on an adjusted transport block (TB) size using a second uplink transmission that is located at an end of a transmit time interval (TTI), and
wherein a portion of the second uplink transmission located in the TTI is equal to or smaller than the first uplink transmission, located in the TTI, by at least one neighbor UE.

14. A method for operation of a user equipment (UE) in a wireless communication system, the method comprising:
receiving, from a base station (BS) over a first downlink channel, a neighbor cell list comprising at least one neighbor cell;
measuring a reference signal received power (RSRP) of a reference signal (RS) received from the at least one neighbor cell included in the neighbor cell list;
generating an indication based on the measured RSRP of the RS that is compared with a first threshold configured by the BS; and
transmitting the indication to the BS over an uplink channel.

15. The method of claim 14, further comprising:
determining uplink-to-downlink interference based on the measured RSRP of the RS received from the at least one neighbor cell included in the neighbor cell list; and
transmitting the measured RSRP of the RS to the BS over the uplink channel.

16. The method of claim 14, further comprising:
receiving, from the BS, configuration information including first discovery RS information over the first downlink channel; and
transmitting, to at least one neighbor UE, a first discovery RS based on the configuration information received from the BS over the first downlink channel.

17. The method of claim 16, further comprising:
measuring a second discovery RS received from the at least one neighbor UE; and
identifying uplink-to-downlink interference based on the measured second discovery RS received from the at least one neighbor UE; and
transmitting information indicating the identified uplink-to-downlink interference to the BS.

18. The method of claim 14, further comprising:
receiving information for a clear channel assessment (CCA) operation from the BS for an uplink transmission by the UE;
measuring signal energy of a channel for the uplink transmission; and
determining whether to adjust a length of the uplink transmission based on a result of the measurement.

19. The method of claim 18, further comprising:
determining whether the CCA operation is available based on a second threshold that is configured by the BS; and
transmitting a first uplink transmission using the uplink transmission based on a result of the determination of whether the CCA operation is available.

20. The method of claim 18, further comprising:
adjusting a transport block (TB) size of a second uplink transmission when uplink-to-downlink interference is detected; and
transmitting the second uplink transmission based on the adjusted TB size at an end of a transmit time interval (TTI), wherein a portion of a first uplink transmission located in the TTI is equal to or smaller than the second uplink transmission by at least one neighbor UE located in the TTI,
wherein the channel is measured to detect the uplink transmission will cause uplink-to-downlink interference to a downlink transmission to at least one neighbor UE; and wherein.
